(19) United States
(12) Patent Application Publication
(10) Pub. No.: US 2012/0012257 A1
(43) Pub. Date: Jan. 19, 2012

(54) DISPENSING UNIT FOR A THIN FILM DISPENSER AND THIN FILM DISPENSER HAVING THE SAME

(75) Inventor: Chien-Lung WU, CHANG HUA (TW)

(73) Assignee: SDI CORPORATION, CHANG HUA (TW)

(21) Appl. No.: 13/179,334

(22) Filed: Jul. 8, 2011

(30) Foreign Application Priority Data
Jul. 14, 2010 (TW) 099123091

(51) Int. Cl. B29C 65/80

(52) U.S. Cl. 156/459

(57) ABSTRACT

A dispensing unit for a thin film dispenser has a base, a dispensing head, a wheel assembly, a transmission device, a thin film and a holding tab. The dispensing head is mounted on one end of the base. The wheel assembly is mounted on the base and has a tape supplying wheel and a used tape collecting wheel. The tape supplying wheel and the used tape collecting wheel are mounted rotatably on the base. The transmission device is mounted between the tape supplying wheel and the used tape collecting wheel to drive the tape supplying wheel and the used tape collecting wheel to rotate simultaneously. The thin film is mounted around the wheel assembly and the dispensing head. The holding tab is connected to the base and abutting with a side face of the tape supplying wheel.

### BACKGROUND OF THE INVENTION

1. Field of the Invention

The present invention relates to a dispensing unit and a thin film dispenser having the same, and more particularly to a dispensing unit having a capability of holding a tape wheel in position securely.

2. Description of Related Art

A correction tape dispenser is used to dispense a correction tape onto a sheet of paper or the like to correct errors on the paper. With reference to FIGS. 8 and 9, a conventional correction tape dispenser comprises a housing and a correction tape dispensing unit 60 mounted in the housing. The correction tape dispensing unit 60 comprises a base 61, a dispensing head 62 and a wheel assembly 64. The dispensing head 62 is mounted on one end of the base 61. The wheel assembly 64 comprises a tape supplying wheel 642 and a used tape collecting wheel 644 mounted rotatably on the other end of the base 61 and driven to rotate with each other. A correction tape is mounted around the wheel assembly 64 and the dispensing head 62. In use, the dispensing head 62 is pushed out of the housing and abuts against and onto a sheet of paper, and the housing is pushed to move to make the correction tape released from the tape supplying wheel 642 and dispensed on and coat the paper to cover the error parts on the paper. The used tape will be collected around the used tape colleting wheel 644, such that the correction tape can be continuously dispensed for use.

In addition, a transmission ring 66 is mounted between the tape supplying wheel 642 and the used tape collecting wheel 644 to rotate the wheels 642,644 simultaneously. Accordingly, the used tape can be collected around the used tape collecting wheel 644 while the tape supplying wheel 642 is rotating to release the correction tape. In addition, the base 61 has a wheel axle 612 formed on and protruding from the base 61, and the tape supplying wheel 642 is mounted rotatably around the wheel axle 612. The wheel axle 612 has a resilient hook 613 formed on the top of the wheel axle 612 and clamps onto a side of the tape supplying wheel 642 to hold the tape supplying wheel 642 rotatably on the wheel axle 612 and to keep the tape supplying wheel 642 from detaching from the wheel axle 612.

However, the transmission ring 66 mounted between the tape supplying wheel 642 and the used tape collecting wheel 644 will provide a force to pull the wheels 642,644 toward each other. Thus, the tape supplying wheel 642 may be inclined due to the force provided by the transmission ring 66 as shown in FIG. 10. Accordingly, the inclined tape supplying wheel 642 will cause the correction tape to be dispensed unsmoothly and negatively influence the quality and smoothness of the use of the correction tape. In addition, the hook 613 on the wheel axle 612 is a thin and elongated structure, so the hook 613 has only a single function of preventing the tape supplying wheel 642 from detaching from the wheel axle 612 but cannot provide a holding effect to prevent the tape supplying wheel 642 from being inclined due to the force provided by the transmission ring 66. Furthermore, the thin and elongated hook 613 is easily deformed during the manufacturing or assembling process of the correction tape dispenser, such that the hook 613 cannot securely hold the tape supplying wheel 642 in position. Consequently, the tape supplying wheel 642 is easily detached from the base 61 to cause inconvenience in use of the conventional correction tape dispenser.

To overcome the shortcomings, the present invention tends to provide a dispensing unit for a thin film dispenser to mitigate or obviate the aforementioned problems.

### SUMMARY OF THE INVENTION

The main objective of the invention is to provide a dispensing unit for a thin film dispenser and a thin film dispenser having the same to improve the stability and smoothness of the operation of a wheel assembly.

The dispensing unit in accordance with the present invention has a base, a dispensing head, a wheel assembly, a transmission device, a thin film and a holding tab. The dispensing head is mounted on one end of the base. The wheel assembly is mounted on the base and has a tape supplying wheel and a used tape collecting wheel. The tape supplying wheel and the used tape collecting wheel are mounted rotatably on the base. The transmission device is mounted between the tape supplying wheel and the used tape collecting wheel to drive the tape supplying wheel and the used tape collecting wheel to rotate simultaneously. The thin film is mounted around the wheel assembly and the dispensing head. The holding tab is connected to the base and abutting with a side face of the tap supplying wheel.

The thin film dispenser in accordance with the present invention has a housing and a dispensing unit. The dispensing unit is mounted in the housing and has a base, a dispensing head, a wheel assembly, a transmission device, a thin film and a holding tab. The dispensing head is mounted on one end of the base. The wheel assembly is mounted on the base and has a tape supplying wheel and a used tape collecting wheel. The tape supplying wheel and the used tape collecting wheel are mounted rotatably on the base. The transmission device is mounted between the tape supplying wheel and the used tape collecting wheel to drive the tape supplying wheel and the used tape collecting wheel to rotate simultaneously. The thin film is mounted around the wheel assembly and the dispensing head. The holding tab is connected to the base and abutting with a side face of the tape supplying wheel.

With such an arrangement, the holding tab can hold the tape supplying wheel on the base firmly to keep the tape supplying wheel from being detached from the base and from being inclined. Thus, the stability of the operation of the wheel assembly is improved, and dispensing of and coating with the thin film are smooth.

In addition, the holding tab in accordance with the present invention can provide a stable and firm combination effect to the tape supplying wheel. The wide and flat holding tab is not easily deformed, such that the tape supplying wheel can be prevented from being detached from the base so as to improve the stabilization of the structure and operation of the dispensing unit.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a thin film dispenser with a dispensing unit in accordance with the present invention;

FIG. 2 is an exploded perspective view of the thin film dispenser in FIG. 1;

FIG. 3 is a side view in partial section of the thin film dispenser in FIG. 1;

FIG. 4 is an enlarged partially exploded perspective view of the dispensing unit in FIG. 1;

FIG. 5 is an enlarged cross sectional side view of the dispensing unit in FIG. 1;

FIG. 6 is a partial perspective view of another embodiment of a dispensing unit in accordance with the present invention;

FIG. 7 is an enlarged cross sectional side view of the dispensing unit in FIG. 6;

FIG. 8 is an exploded perspective view of a conventional dispensing unit for a correction tape dispenser in accordance with the prior art;

FIG. 9 is an enlarged cross sectional side view of the conventional dispensing unit in FIG. 8; and

FIG. 10 is an operational cross sectional side view of the conventional dispensing unit in FIG. 8 showing the tape supplying wheel being inclined due to the force provided by the transmission ring.

### DETAILED DESCRIPTION OF PREFERRED EMBODIMENT

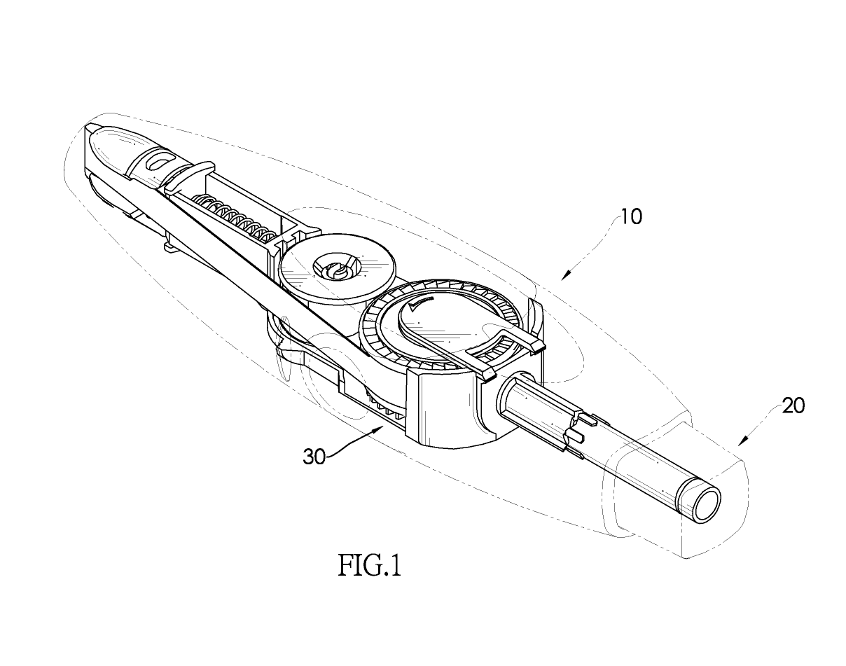

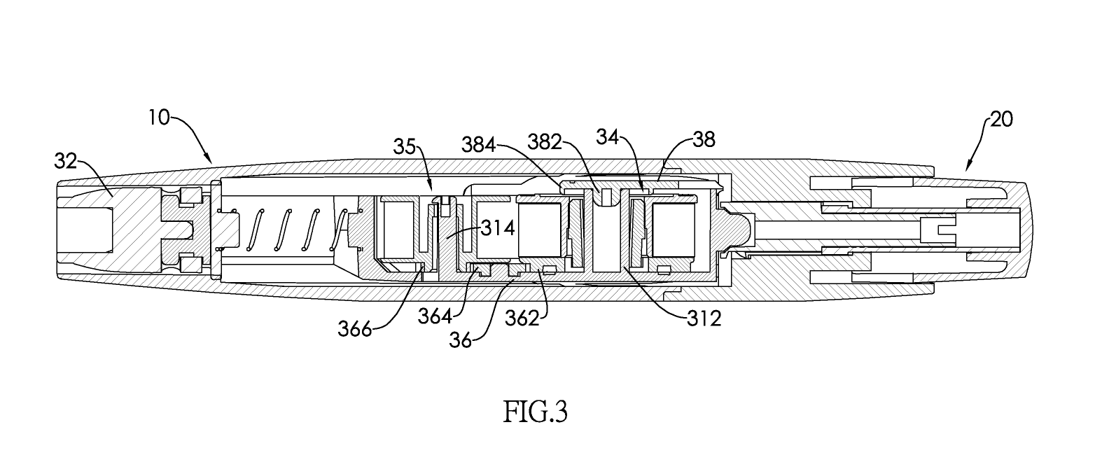

With reference to FIGS. 1 to 3, a thin film dispenser in accordance with the present invention may be a correction tape dispenser, an adhesive tape dispenser or the like and includes all kinds of apparatus that can apply a thin film onto a desired location. The thin film dispenser has a housing 10 and a dispensing unit 30. The housing 10 has a chamber defined in the housing 10 to hold the dispensing unit 30 inside and may be composed of two casings combined with each other. The casings may be front and rear casings as shown, upper and lower casings, right and left casings or the like. As long as the housing is in a detachable form, the format, number and combination method of the casings are not limited in the present invention. The dispensing unit 30 may inherently protrude out from the housing 10 in a normal condition. At this time, a cap is further provided to cover the protruding portion of the dispensing unit 30 out of the housing 10 to keep the dispensing unit 30 from contacting another object while not in use. In addition, the dispensing unit 30 may be retracted completely into the housing 10 in a normal condition as shown in FIG. 1. At this time, a retracting device 20 is further provided to extend the dispensing unit 30 out of the housing 10 for use. The retracting device 20 may be a button assembly as shown, a rotatable knob, a pushing assembly or the like. As long as the retracting device 20 has a function of extending the dispensing unit 30 out of the housing 10, the format and structure of the retracting device 20 are not limited in the present invention.

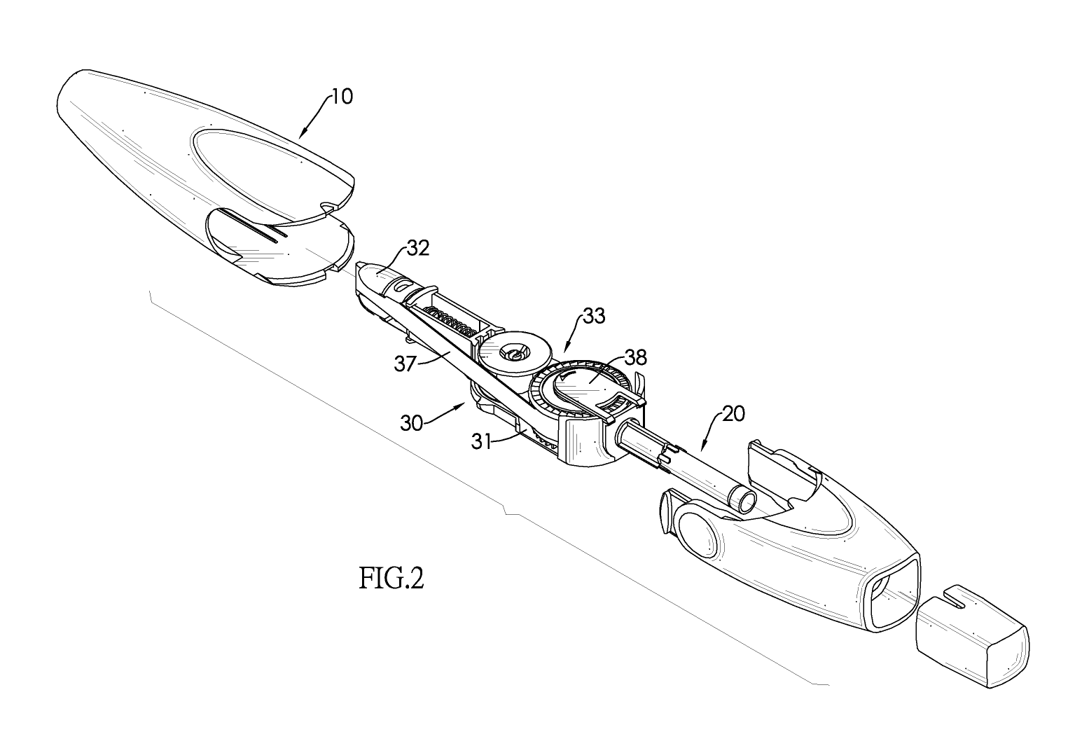

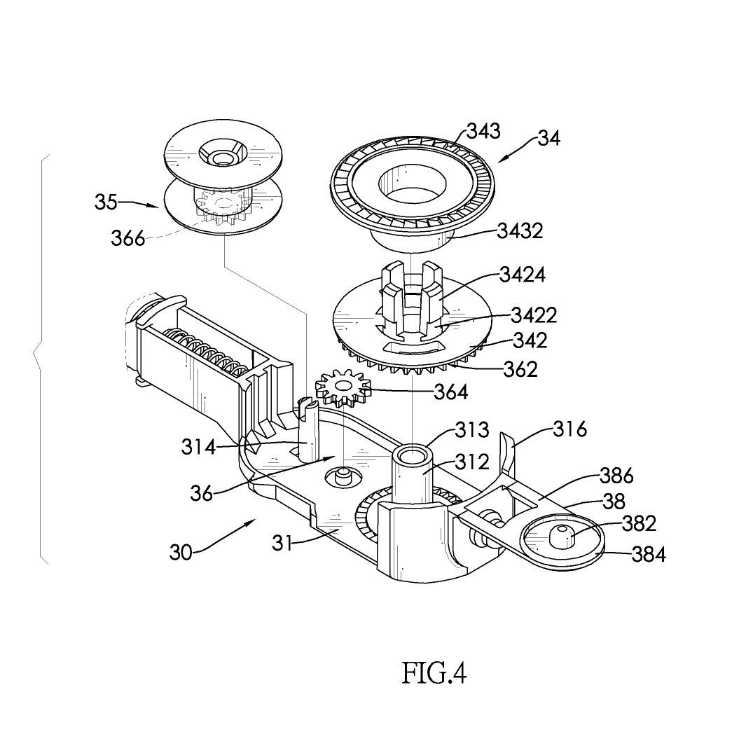

With reference to FIGS. 2 to 4, the dispensing unit 30 in accordance with the present invention comprises a base 31, a dispensing head 32, a wheel assembly 33, a transmission device 36, a thin film 37 and a holding tab 38. The dispensing head 32 is mounted on one end of the base 31 and can inherently protrude out of or be pushed to extend out of the housing 10. The wheel assembly 33 is mounted on the other end of the base 31 and comprises a tape supplying wheel 34 and a used tape collecting wheel 35. The tape supplying wheel 34 and the used tape colleting wheel 35 are respectively mounted rotatably around a supplying wheel axle 312 and a collecting wheel axle 314 formed on the base 31. The supplying wheel axle 312 has an open top end to form an engaging hole 313 in the top end of the supplying wheel axle 312. The top end of the supplying wheel axle 312 has a height relative to the base 31 and higher than that of the side face of the tape supplying wheel 34. In addition, the tape supplying wheel 34 may be composed of a first half wheel 342 and a second half wheel 343 combined with the first half wheel 342. With further reference to FIG. 5, a brake device is mounted between the first and second half wheels 342,343 and comprises multiple resilient braking arms 3422 and a connecting tube 3432. The resilient braking arms 3422 are formed on and protrude from the first half wheel 342 and are arranged in a circle. Each braking arm 3422 has a braking block 3424 formed on a top at an outer side of the braking arm 3422. The connecting tube 3432 is formed on and protrudes from the second half wheel 343, is mounted around the braking arms 3422 and has an inner surface abutting with the braking blocks 3424 on the braking arms 3422.

The transmission device 36 is mounted between the tape supplying wheel 34 and the used tape collecting wheel 35 to drive the tape supplying wheel 34 and the used tape collecting wheel 35 to rotate simultaneously. The transmission device 36 may comprise a supplying wheel gear 362, a collecting wheel gear 366 and a transmitting gear 364. The supplying wheel gear 362 is mounted co-axially with the tape supplying wheel 34. Preferably, the supplying wheel gear 362 is mounted on a side face of the first half wheel 342 of the tape supplying wheel 34. The collecting wheel gear 366 is mounted co-axially with the used tape collecting wheel 35. The transmitting gear 364 is mounted rotatably on the base 31 and engages the supplying wheel gear 362 and the collecting wheel gear 366. Accordingly, while the tape supplying wheel 34 is rotating, the used tape collecting wheel 35 will be simultaneously rotating in the same rotating direction of the tape supplying wheel 34 via the transmission of the gears 362,364,366.

The thin film 37 is mounted around the wheel assembly 33 and the dispensing head 32 and has an unused end mounted around the tape supplying wheel 34 and a used end mounted around the used tape collecting wheel 35 after mounting over the dispensing head 32. Preferably, the unused end of the thin film 37 is mounted around the connecting tube 3432 on the second half wheel 343 of the tape supplying wheel 34.

The holding tab 38 is connected to the base 31 at the end on which the wheel assembly 33 is mounted. The holding tab 38 may be integrally connected to the end of the base 31 or may be an individual element mounted securely on the base 31. The holding tab 38 may be a wide and flat sheet and abuts with the side face of the tape supplying wheel 34. The holding tab 38 has an engaging protrusion 382 formed on the holding tab 38 at a side facing the tape supplying wheel 34 and engaging the engaging hole 313 in the top end of the supplying wheel axle 312. With the engagement between the engaging protrusion 382 and the engaging hole 313, the holding tab 38 is securely connected with the supplying wheel axle 312. Accordingly, the tape supplying wheel 34 is held between the base 31 and the holding tab 38 to keep the tape supplying wheel 34 from being detached from the base 31. In addition, the holding tab 38 may further have a pressing rib 384 formed on the holding tab 38 at a side facing the tape supplying wheel 34 and abutting with the side face of the tape supplying wheel 34. The pressing rib 384 may be annular and has a center at the engaging protrusion 382. With the arrangement of the pressing rib 384, the tape supplying wheel 34 can be further actually prevented from being inclined while rotating, such that the rotation of the tape supplying wheel 34 and the dispensation of the thin film 37 are smooth.

In addition, the holding tab 38 may have at least one connecting arm 386 protruding from the holding tab 38 and connected to the base 31. Preferably, two connecting arms 386 are implemented. Each connecting arm 386 is connected integrally with the base 31 and has a bendable conjunction segment connected to the base 31, such that the holding tab 38 is integrally connected with the base 31 via the connecting arms 386. Alternatively, each connecting arm 386 on the holding tab 38 is detachably connected to the base 31 in an engaging or hooking manner, such that an individual holding tab 38 can be connected securely with the base 31. In addition, the base 31 further has two limiting protrusions 316 separately formed on the base 31 at a position with which the holding tab 38 is connected, and the at least one connecting arm 386 on the holding tab 38 extends between and abuts with the limiting protrusions 316. With the arrangement of the limiting protrusions 316, the holding tab 38 can be kept from rotating relative to the supplying wheel axle 312.

In use, with reference to FIGS. 1 to 3, after removing the cap or pushing the dispensing head 32 out of the housing 10 by the retracting device 20, the dispensing head 32 is put against and onto a sheet of paper and the housing 10 is pushed to move along the paper to coat the paper with the thin film 37 for covering the error portions on the paper. At this time, the movement of the thin film 37 can drive the first half wheel 342 and the second half wheel 343 of the tape supplying wheel 34 to rotate, such that the unused thin film 37 can be released from the tape supplying wheel 34. Meanwhile, the used tape collecting wheel 35 is rotated via the transmission of the transmission device 36 to collect and reel the used tape around the used tape collecting wheel 35. Consequently, the thin film 37 can be continuously dispensed for use. When the user stops coating the paper with the thin film 37, the second half wheel 343 will be stopped by the friction generated between the braking blocks 3424 on the braking arms 3422 and the inner surface of the connecting tube 3432. Consequently, the thin film 37 can be stopped from being released from the tape supplying wheel 34.

Because the holding tab 38 abuts with the tape supplying wheel 34, the tape supplying wheel 34 can be kept from being detached from the base 31 and the rotating range of the tape supplying wheel 34 can also be limited so that the tape supplying wheel 34 can be prevented from being inclined or being detached from the supplying wheel axle 312. Accordingly, the thin film 37 can be dispensed stably and be coated on the paper smoothly.

Furthermore, because the holding tab 38 is a wide and flat sheet, the holding tab 38 is not easily deformed during the manufacturing or assembling process and can be securely connected to the supplying wheel axle 312 to keep the tape supplying wheel 34 from being unintentionally detached from the base 31. Moreover, with the arrangement of the limiting protrusions 316, the holding tab 38 is kept from rotating relative to the supplying wheel axle 312 even when the connecting arms 386 are detached or broken from the base 31. The structure of the whole dispensing unit 30 is stable and firm.

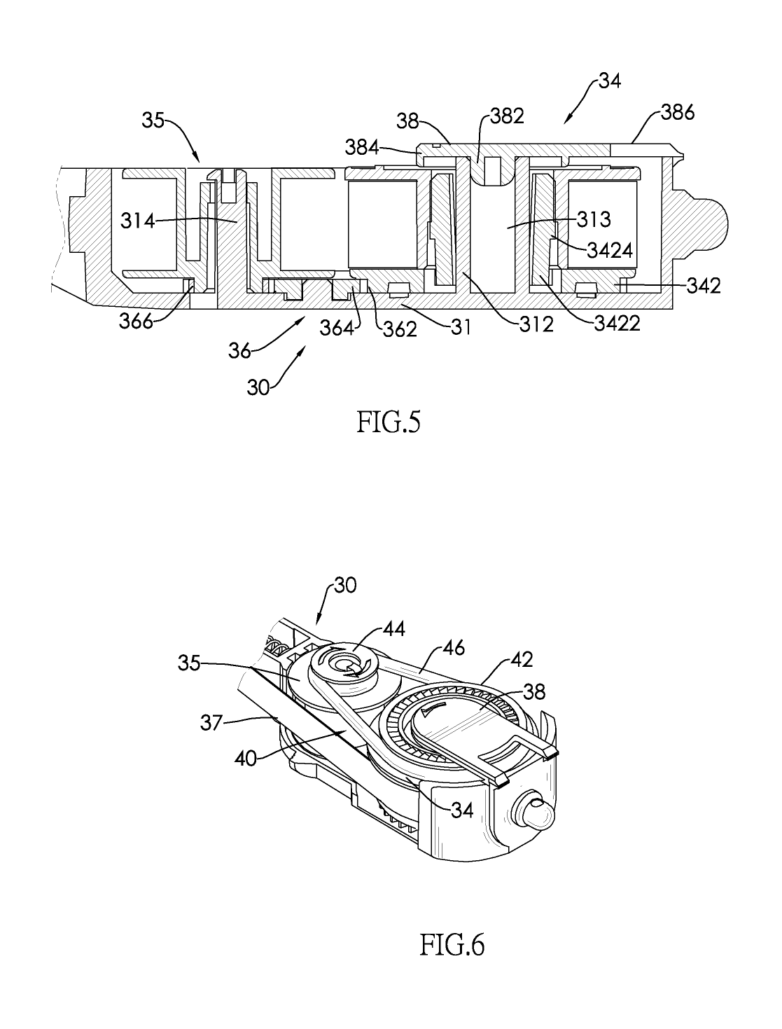

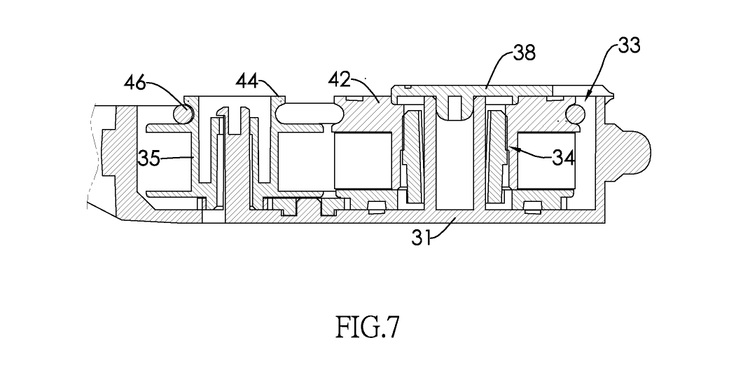

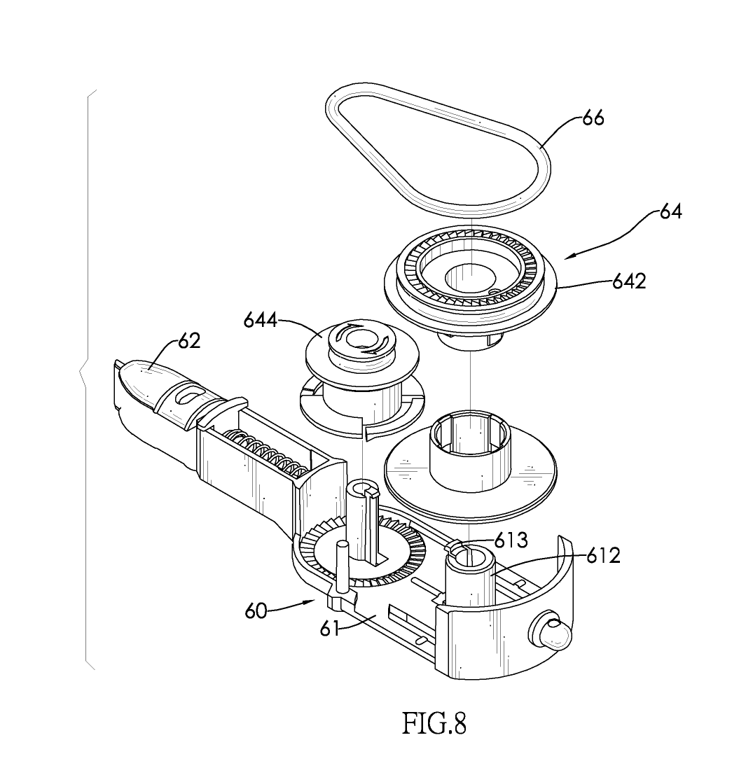

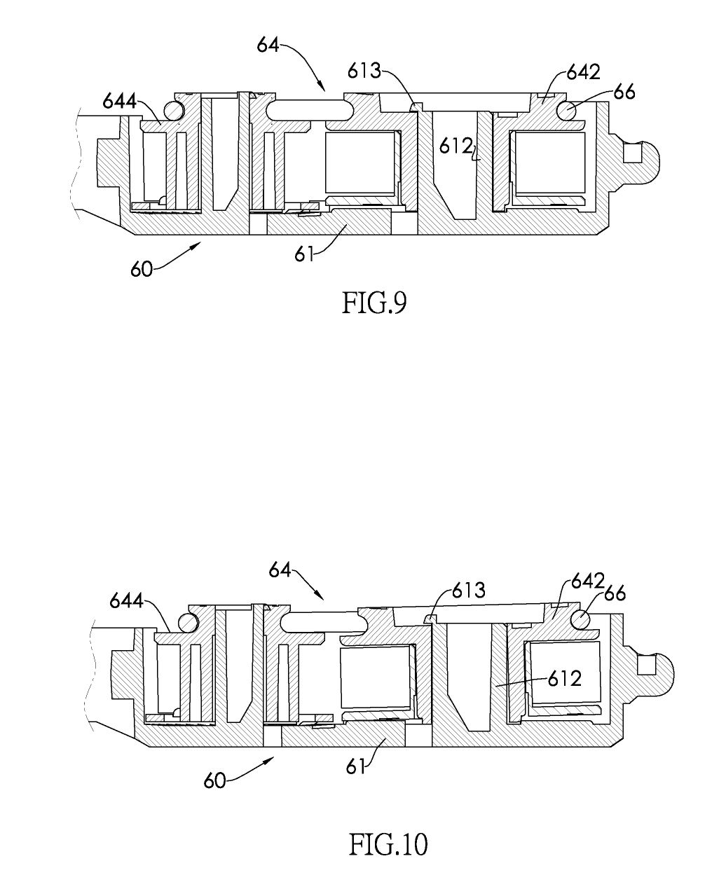

With reference to FIGS. 6 and 7, in another embodiment, the transmission device 40 may comprise two transmission pulleys 42,44 and a transmission belt 46. The transmission pulleys 42,44 are respectively mounted co-axially with the tape supplying wheel 34 and the used tape collecting wheel 35. The transmission belt 46 is mounted around the transmission pulleys 42,44. Accordingly, when the tape supplying wheel 34 is rotating, the used tape collecting wheel 35 can be rotated simultaneously with the transmission of the transmission pulleys 42,44 and belt 46 to enable the thin film 37 to be released and collected.

In this embodiment, even the transmission belt 46 may provide a force to pull the tape supplying wheel 34 and the used tape collecting wheel 35 toward each other, the tape supplying wheel 34 can be kept from being inclined by the arrangement of the holding tab 38 that abuts with the tape supplying wheel 34. Accordingly, the rotation of the wheel assembly 33 is stable and smooth.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A dispensing unit for a thin film dispenser comprising:
a base;
a dispensing head mounted on one end of the base;
a wheel assembly mounted on the base and comprising
a tape supplying wheel mounted rotatably on the base; and
a used tape collecting wheel mounted rotatably on the base;
a transmission device mounted between the tape supplying wheel and the used tape collecting wheel to drive the tape supplying wheel and the used tape collecting wheel to rotate simultaneously;
a thin film mounted around the wheel assembly and the dispensing head; and
a holding tab connected to the base and abutting with a side face of the tape supplying wheel.

2. The dispensing unit as claimed in claim 1, wherein
the base comprises a supplying wheel axle formed on the base, around which the tape supplying wheel is rotatably mounted and having an open top end to form an engaging hole in the top end of the supplying wheel axle; and
the holding tab has an engaging protrusion formed on the holding tab at a side facing the tape supplying wheel and engaging the engaging hole in the top end of the supplying wheel axle.

3. The dispensing unit as claimed in claim 2, wherein the top end of the supplying wheel axle has a height relative to the base and higher than that of the side face of the tape supplying wheel with which the holding tab abuts.

4. The dispensing unit as claimed in claim 3, wherein the holding tab has a pressing rib formed on the holding tab at a side facing the tape supplying wheel and abutting with the side face of the tape supplying wheel.

5. The dispensing unit as claimed in claim 4, wherein the holding tab has at least one connecting arm protruding from the holding tab and connected to the base.

6. The dispensing unit as claimed in claim 5, wherein the at least one connecting arm is connected integrally with the base and each one of the at least one connecting arm has a bendable conjunction segment connected to the base.

7. The dispensing unit as claimed in claim 6, wherein the base has two limiting protrusions separately formed on the base at a position with which the holding tab is connected; and
the at least one connecting arm extends between and abuts with the limiting protrusions.

8. The dispensing unit as claimed in claim 7, wherein the transmission device comprises
a supplying wheel gear mounted co-axially with the tape supplying wheel;
a collecting wheel gear mounted co-axially with the used tape collecting wheel; and
a transmitting gear mounted rotatably on the base and engaging the supplying wheel gear and the collecting wheel gear.

9. The dispensing unit as claimed in claim 8, wherein the tape supplying wheel comprises
a first half wheel;
a second half wheel combined with the first half wheel; and
a brake device mounted between the first and second half wheels and comprising
multiple resilient braking arms formed on and protruding from the first half wheel and arranged in a circle, and each braking arm having a braking block formed on a top at an outer side of the braking arm; and
a connecting tube formed on and protruding from the second half wheel, mounted around the braking arms and having an inner surface abutting with the braking blocks on the braking arms.

10. The dispensing unit as claimed in claim 7, wherein the transmission device comprises
two transmission pulleys respectively mounted co-axially with the tape supplying wheel and the used tape collecting wheel; and
a transmission belt mounted around the transmission pulleys.

11. The dispensing unit as claimed in claim 10, wherein the tape supplying wheel comprises
a first half wheel;
a second half wheel combined with the first half wheel; and
a brake device mounted between the first and second half wheels and comprising
multiple resilient braking arms formed on and protruding from the first half wheel and arranged in a circle, and each braking arm having a braking block formed on a top at an outer side of the braking arm; and
a connecting tube formed on and protruding from the second half wheel, mounted around the braking arms and having an inner surface abutting with the braking blocks on the braking arms.

12. The dispensing unit as claimed in claim 5, wherein the at least one connecting arm on the holding tab is detachably connected to the base.

13. The dispensing unit as claimed in claim 12, wherein the base has two limiting protrusions separately formed on the base at a position with which the holding tab is connected; and
the at least one connecting arm extends between and abuts with the limiting protrusions.

14. The dispensing unit as claimed in claim 13, wherein the transmission device comprises
a supplying wheel gear mounted co-axially with the tape supplying wheel;
a collecting wheel gear mounted co-axially with the used tape collecting wheel; and
a transmitting gear mounted rotatably on the base and engaging the supplying wheel gear and the collecting wheel gear.

15. The dispensing unit as claimed in claim 14, wherein the tape supplying wheel comprises
a first half wheel;
a second half wheel combined with the first half wheel; and
a brake device mounted between the first and second half wheels and comprising
multiple resilient braking arms formed on and protruding from the first half wheel and arranged in a circle, and each braking arm having a braking block formed on a top at an outer side of the braking arm; and
a connecting tube formed on and protruding from the second half wheel, mounted around the braking arms and having an inner surface abutting with the braking blocks on the braking arms.

16. The dispensing unit as claimed in claim 13, wherein the transmission device comprises
two transmission pulleys respectively mounted co-axially with the tape supplying wheel and the used tape collecting wheel; and
a transmission belt mounted around the transmission pulleys.

17. The dispensing unit as claimed in claim 16, wherein the tape supplying wheel comprises
a first half wheel;
a second half wheel combined with the first half wheel; and
a brake device mounted between the first and second half wheels and comprising
multiple resilient braking arms formed on and protruding from the first half wheel and arranged in a circle, and each braking arm having a braking block formed on a top at an outer side of the braking arm; and
a connecting tube formed on and protruding from the second half wheel, mounted around the braking arms and having an inner surface abutting with the braking blocks on the braking arms.

18. The dispensing unit as claimed in claim 1, wherein the transmission device comprises
a supplying wheel gear mounted co-axially with the tape supplying wheel;
a collecting wheel gear mounted co-axially with the used tape collecting wheel; and
a transmitting gear mounted rotatably on the base and engaging the supplying wheel gear and the collecting wheel gear.

19. The dispensing unit as claimed in claim 1, wherein the tape supplying wheel comprises
a first half wheel;
a second half wheel combined with the first half wheel; and
a brake device mounted between the first and second half wheels and comprising
multiple resilient braking arms formed on and protruding from the first half wheel and arranged in a circle, and each braking arm having a braking block formed on a top at an outer side of the braking arm; and
a connecting tube formed on and protruding from the second half wheel, mounted around the braking arms and having an inner surface abutting with the braking blocks on the braking arms.

20. The dispensing unit as claimed in claim 1, wherein the transmission device comprises
two transmission pulleys respectively mounted co-axially with the tape supplying wheel and the used tape collecting wheel; and
a transmission belt mounted around the transmission pulleys.

21. The dispensing unit as claimed in claim 1, wherein the holding tab has a pressing rib formed on the holding tab at a side facing the tape supplying wheel and abutting with the side face of the tape supplying wheel.

22. A thin film dispenser comprising:
a housing;
a dispensing unit mounted in the housing and comprising
a base;
a dispensing head mounted on one end of the base;
a wheel assembly mounted on the base and comprising
a tape supplying wheel mounted rotatably on the base; and
a used tape collecting wheel mounted rotatably on the base;
a transmission device mounted between the tape supplying wheel and the used tape collecting wheel to drive the tape supplying wheel and the used tape collecting wheel to rotate simultaneously;
a thin film mounted around the wheel assembly and the dispensing head; and
a holding tab connected to the base and abutting with a side face of the tape supplying wheel.

23. The thin film dispenser as claimed in claim 22, wherein
the base comprises a supplying wheel axle formed on the base, around which the tape supplying wheel is rotatably mounted and having an open top end to form an engaging hole in the top end of the supplying wheel axle; and
the holding tab has an engaging protrusion formed on the holding tab at a side facing the tape supplying wheel and engaging the engaging hole in the top end of the supplying wheel axle.

24. The thin film dispenser as claimed in claim 23, wherein the top end of the supplying wheel axle has a height relative to the base and higher than that of the side face of the tape supplying wheel with which the holding tab abuts.

25. The thin film dispenser as claimed in claim 24, wherein the holding tab has a pressing rib formed on the holding tab at a side facing the tape supplying wheel and abutting with the side face of the tape supplying wheel.

26. The thin film dispenser as claimed in claim 25, wherein the holding tab has at least one connecting arm protruding from the holding tab and connected to the base.

27. The thin film dispenser as claimed in claim 26, wherein the at least one connecting arm is connected integrally with the base and each one of the at least one connecting arm has a bendable conjunction segment connected to the base.

28. The thin film dispenser as claimed in claim 27, wherein the base has two limiting protrusions separately formed on the base at a position with which the holding tab is connected; and
the at least one connecting arm extends between and abuts with the limiting protrusions.

29. The thin film dispenser as claimed in claim 28, wherein the transmission device comprises
a supplying wheel gear mounted co-axially with the tape supplying wheel;
a collecting wheel gear mounted co-axially with the used tape collecting wheel; and
a transmitting gear mounted rotatably on the base and engaging the supplying wheel gear and the collecting wheel gear.

30. The thin film dispenser as claimed in claim 29, wherein the tape supplying wheel comprises
a first half wheel;
a second half wheel combined with the first half wheel; and
a brake device mounted between the first and second half wheels and comprising
multiple resilient braking arms formed on and protruding from the first half wheel and arranged in a circle, and each braking arm having a braking block formed on a top at an outer side of the braking arm; and
a connecting tube formed on and protruding from the second half wheel, mounted around the braking arms and having an inner surface abutting with the braking blocks on the braking arms.

31. The thin film dispenser as claimed in claim 30 further comprising a retracting device for extending the dispensing unit out of the housing.

32. The thin film dispenser as claimed in claim 28, wherein the transmission device comprises
two transmission pulleys respectively mounted co-axially with the tape supplying wheel and the used tape collecting wheel; and
a transmission belt mounted around the transmission pulleys.

33. The thin film dispenser as claimed in claim 32, wherein the tape supplying wheel comprises
a first half wheel;
a second half wheel combined with the first half wheel; and
a brake device mounted between the first and second half wheels and comprising
multiple resilient braking arms formed on and protruding from the first half wheel and arranged in a circle, and each braking arm having a braking block formed on a top at an outer side of the braking arm; and
a connecting tube formed on and protruding from the second half wheel, mounted around the braking arms and having an inner surface abutting with the braking blocks on the braking arms.

34. The thin film dispenser as claimed in claim 33 further comprising a retracting device for extending the dispensing unit out of the housing.

35. The thin film dispenser as claimed in claim 26, wherein the at least one connecting arm on the holding tab is detachably connected to the base.

36. The thin film dispenser as claimed in claim 35, wherein the base has two limiting protrusions separately formed on the base at a position with which the holding tab is connected; and
the at least one connecting arm extends between and abuts with the limiting protrusions.

37. The thin film dispenser as claimed in claim 36, wherein the transmission device comprises
a supplying wheel gear mounted co-axially with the tape supplying wheel;
a collecting wheel gear mounted co-axially with the used tape collecting wheel; and
a transmitting gear mounted rotatably on the base and engaging the supplying wheel gear and the collecting wheel gear.

38. The thin film dispenser as claimed in claim 37, wherein the tape supplying wheel comprises
a first half wheel;
a second half wheel combined with the first half wheel; and
a brake device mounted between the first and second half wheels and comprising
multiple resilient braking arms formed on and protruding from the first half wheel and arranged in a circle, and each braking arm having a braking block formed on a top at an outer side of the braking arm; and
a connecting tube formed on and protruding from the second half wheel, mounted around the braking arms and having an inner surface abutting with the braking blocks on the braking arms.

39. The thin film dispenser as claimed in claim 38 further comprising a retracting device for extending the dispensing unit out of the housing.

40. The thin film dispenser as claimed in claim 36, wherein the transmission device comprises
two transmission pulleys respectively mounted co-axially with the tape supplying wheel and the used tape collecting wheel; and
a transmission belt mounted around the transmission pulleys.

41. The thin film dispenser as claimed in claim 40, wherein the tape supplying wheel comprises
a first half wheel;
a second half wheel combined with the first half wheel; and
a brake device mounted between the first and second half wheels and comprising
multiple resilient braking arms formed on and protruding from the first half wheel and arranged in a circle, and each braking arm having a braking block formed on a top at an outer side of the braking arm; and
a connecting tube formed on and protruding from the second half wheel, mounted around the braking arms and having an inner surface abutting with the braking blocks on the braking arms.

42. The thin film dispenser as claimed in claim 41 further comprising a retracting device for extending the dispensing unit out of the housing.

43. The thin film dispenser as claimed in claim 22, wherein the transmission device comprises
a supplying wheel gear mounted co-axially with the tape supplying wheel;
a collecting wheel gear mounted co-axially with the used tape collecting wheel; and
a transmitting gear mounted rotatably on the base and engaging the supplying wheel gear and the collecting wheel gear.

44. The thin film dispenser as claimed in claim 22, wherein the tape supplying wheel comprises
a first half wheel;
a second half wheel combined with the first half wheel; and
a brake device mounted between the first and second half wheels and comprising
multiple resilient braking arms formed on and protruding from the first half wheel and arranged in a circle, and each braking arm having a braking block formed on a top at an outer side of the braking arm; and
a connecting tube formed on and protruding from the second half wheel, mounted around the braking arms and having an inner surface abutting with the braking blocks on the braking arms.

45. The thin film dispenser as claimed in claim 22, wherein the transmission device comprises
two transmission pulleys respectively mounted co-axially with the tape supplying wheel and the used tape collecting wheel; and
a transmission belt mounted around the transmission pulleys.

46. The thin film dispenser as claimed in claim 22 further comprising a retracting device for extending the dispensing unit out of the housing.

47. The thin film dispenser as claimed in claim 22, wherein the holding tab has a pressing rib formed on the holding tab at a side facing the tape supplying wheel and abutting with the side face of the tape supplying wheel.
